(19) United States
(12) Patent Application Publication
(10) Pub. No.: US 2026/0054352 A1
(43) Pub. Date: Feb. 26, 2026

(54) Cutting Disk With Diamonds In Metal Sinter Matrix

(71) Applicant: Klingspor AG, Haiger (DE)

(72) Inventors: Stefan Neubach, Haiger (DE); Oleksandr Filatov, Haiger (DE)

(21) Appl. No.: 19/103,621

(22) PCT Filed: Jan. 31, 2023
(86) PCT No.: PCT/EP2023/052308

§ 371 Date: Feb. 13, 2025

(30) Foreign Application Priority Data
Aug. 16, 2022 (DE) 10 2022 120 644.0

(51) Int. Cl. B24D 3/06; B24D 5/12; C04B 35/117

(52) U.S. Cl. CPC B24D 3/06; B24D 5/123; C04B 35/117

(57) ABSTRACT

A cutting wheel includes a core wheel made of a metallic material and cutting segments disposed at the circumference of the core wheel and each having a sintered metal matrix in which diamonds are embedded. Additionally, aluminum oxide particles are embedded in the sintered metal matrix of each of the cutting segments. The aluminum oxide particles are shaped in such a manner that they each have a surface area/volume (A/V) ratio greater than 5.

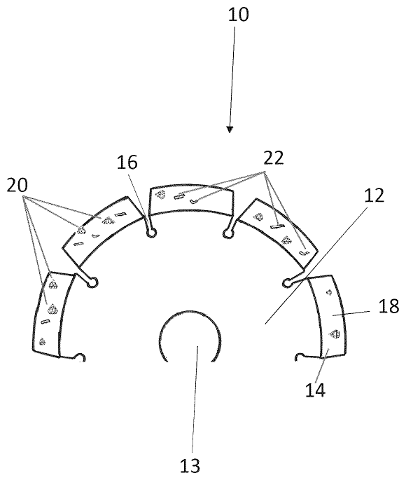

### CROSS-REFERENCE TO RELATED APPLICATIONS

This patent application is a national stage application of International Patent Application No. PCT/EP2023/052308 filed Jan. 31, 2023, which claims priority to German Patent Application No. 10 2022 120 644.0 filed Aug. 16, 2022, the disclosure of which is incorporated herein by reference in its entirety for all purposes.

### TECHNICAL FIELD

The disclosure relates to a cutting wheel.

### BACKGROUND

Cutting wheels are known from practice and are used in the form of diamond saws, in particular for cutting building materials. In terms of design, the cutting wheels each comprise an essentially circular core wheel made of metal, in particular steel, on the circumference of which cutting segments are disposed, which have an arcuate shape following the circumference and each have a sintered metal matrix, which is produced on the basis of cobalt, iron and nickel, for example. Diamonds are embedded in the sintered metal matrix, which give the cutting wheel the properties that enable the cutting or separating of materials such as concrete, natural stone and the like. When cutting highly abrasive materials, such as asphalt, concrete, sandstone and the like, increased requirements are placed on the cutting segments since the cutting process causes a high degree of bond wear, which can cause the diamonds to fall out of the sintered metal matrix prematurely and thus partially unused with the result that the cutting wheel no longer meets the requirements.

### SUMMARY

The object of the disclosure is to create a cutting wheel of the type mentioned above that exhibits improved wear resistance.

According to the disclosure, this object is attained by the cutting wheel having the features disclosed below.

According to the disclosure, a cutting wheel is proposed that comprises a core wheel made of a metallic material and cutting segments that are disposed at the circumference of the core wheel, which is in particular essentially circular, and that each have a sintered metal matrix in which aluminum oxide particles are embedded.

The wear-resistant effect of the aluminum oxide particles can be influenced in particular by their geometry. For instance, it is particularly advantageous for the aluminum oxide particles to each be shaped in such a manner that they have a surface area/volume (A/V) ratio per unit volume that is greater than 5, in particular greater than 5.14. Such an A/V ratio is present in elongated particles, whereas the A/V ratio of compressed or block-like bodies or cuboids is smaller than this value. For example, an elongated cuboid with edge lengths of 6 mm, 0.9 mm and 0.7 mm has a surface area A of 20.46 mm² and a volume of 3.78 mm³, which results in an A/V ratio of 5.41 mm⁻¹. In contrast, a block-like cuboid with edge lengths of 4 mm, 1 mm and 1.2 mm has an A/V ratio of 4.6 mm⁻¹.

The addition of aluminum oxide particles to the sintered metal matrix forming the bonding system considerably increases the wear resistance of the grinding segments. Aluminum oxide is available at a low price, which is why the cutting wheel configured according to the disclosure can also be produced at a low cost. In addition, the aluminum oxide particles can be fine-grained, resulting in cutting edges that contribute to the cutting effect during cutting use on building materials such as asphalt.

The aluminum oxide particles are light in color and therefore stand out clearly from the sintered metal matrix, meaning a customer or user can also perceive the properties of the cutting wheel configured according to the disclosure visually.

The cutting wheel according to the disclosure is particularly suitable for cutting highly abrasive materials such as asphalt, concrete or the like.

Furthermore, it has been shown that the wear resistance of the cutting segments can be improved if the aluminum oxide particles are each rod-shaped.

In another specific embodiment of the cutting wheel according to the disclosure, the aluminum particles are provided with hollows on their surfaces, which leads to a further increase in the surface area/volume (A/V) ratio.

Depending on the application, the content of aluminum oxide particles in the sintered metal matrix can vary. In particular, however, the content of the aluminum oxide particles in the sintered metal matrix is preferably 1 to 30 wt. %, in particular 2 to 20 wt. %, each.

It is contemplated that the aluminum oxide particles are crystalline. The aluminum oxide particles are typically each made of sintered corundum, i.e., a ceramic material.

The aluminum oxide particles can be statically distributed in the sintered metal matrix. In a specific embodiment of the cutting wheel according to the disclosure, however, the aluminum oxide particles are disposed regularly and/or set in patterns in the sintered metal matrix, which can have a positive effect on wear resistance.

The cutting segments are produced in particular by sintering a powder or a granulate.

The sintered metal matrix of the cutting segments of the cutting wheel according to the disclosure can comprise various metals, such as cobalt, iron, tin and nickel. Preferably, the sintered metal matrix has an iron, tin, nickel and/or cobalt content in the range of 8 to 75 wt. %, which is added in the form of powder or granules during the production of the cutting segments.

Furthermore, the sintered metal matrix may comprise copper and/or a copper-based alloy (bronze), preferably in an amount of 5 to 40 wt. %. These components can also be added in powder or granulate form during the production of the cutting segments, i.e., before sintering. The copper added in this manner can react with the aluminum oxide particles and lead to good bonding of the aluminum oxide particles, in particular through a formation of spinel.

In addition, the sintered metal matrix can comprise hard materials and/or a hard-material alloy in an amount of 0.1 to 40 wt. %. The hard-material alloys include, for example, hard materials sold under the brand names Colmonoy or Deloro, which are metallic or intermetallic (self-flowing) hard-material alloys based on nickel, silicon and boron.

Furthermore, it is advantageous if the sintered metal matrix comprises iron phosphide. The content thereof is preferably 0.5 to 50 wt. %. The phosphorus of the iron phosphide reduces the aluminum oxide on the surface of the aluminum oxide particles to metallic aluminum. The latter can be easily sintered with the metal powders or the metal granulates during the production of the cutting segments and increases the hardness of the sintered metal matrix.

The resulting phosphorus-iron bond ensures good wetting of all particles, especially the aluminum oxide particles, during sintering, in particular with the addition of copper and/or tin and/or bronze. Under the influence of a high sintering temperature and a high sintering pressure, the phosphorus could react with aluminum oxide, causing the latter to deoxidize. This results in a thin aluminum coating on the aluminum oxide particles. Said coating ensures that the aluminum particles are well bonded in the sintered metal matrix.

Other advantages and advantageous configurations of the subject matter of the disclosure are apparent from the description, the drawing and the claims.

### BRIEF DESCRIPTION OF THE FIGURE

An example of a cutting wheel according to the disclosure is shown in the drawing in a schematically simplified manner and will be explained in more detail in the following description.

The only Figure of the drawing shows a schematic partial view of a cutting wheel according to the disclosure, which forms a diamond saw.

### DETAILED DESCRIPTION

The drawing shows a cutting wheel 10 that is particularly suitable for cutting materials such as asphalt. The cutting wheel 10 comprises an essentially circular core wheel 12, which is made of steel and has a central hole 13 for a drive shaft of a suitable machine tool.

On its circumference, the core wheel 12 carries a plurality of cutting segments 14, which are disposed one behind the other in the circumferential direction and which are separated from each other by a slot or incision 16, which also extends into the core wheel 12. The cutting segments 14, which constitute the cutting means of the cutting wheel 10 and are connected to the core wheel in particular by a laser welding process in which a CO₂ laser or a fiber laser is used, or alternatively by a brazing process or an adhesive bonding process, each have an arcuate shape in the case at hand, which follows the circumference of the core wheel 12.

The cutting segments 14 each have a sintered metal matrix 18, which is made of 10 to 75 wt. % iron powder, 5 to 40 wt. % copper or copper-based alloy powder, 0 to 40 wt. % hard materials and 0.5 to 15 wt. % iron phosphide powder. Furthermore, the cutting segments 14 each comprise rod-shaped aluminum oxide particles 22 at a content of 1 to 30 wt. % and, as cutting-active substances, diamonds 20. The aluminum oxide particles 22 and the diamonds 20 are embedded in the sintered metal matrix 18.

The aluminum oxide particles 22, which are made of sintered corundum, each have a rod-shaped geometry and a surface area/volume ratio of at least 5.14 per unit length.

In a root area adjacent to the core wheel 12, the cutting segments 14 have in particular a composition that differs from that of the actual cutting matrix and, due to the connecting welding process, contains more cobalt and/or iron and/or nickel and less copper and/or bronze.

### REFERENCE SIGNS

10 cutting wheel
12 core wheel
13 hole
14 cutting segment
16 incision
18 sintered metal matrix
20 diamonds
22 aluminum oxide particles

1. A cutting wheel comprising a core wheel made of a metallic material and cutting segments disposed at the circumference of the core wheel and each having a sintered metal matrix in which diamonds are embedded, aluminum oxide particles being embedded in the sintered metal matrix of each of the cutting segments, wherein the aluminum oxide particles are shaped in such a manner that they each have a surface area/volume (A/V) ratio greater than 5.

2. The cutting wheel according to claim 1, wherein the aluminum oxide particles are each rod-shaped.

3. The cutting wheel according to claim 1, wherein the content of the aluminum oxide particles in the sintered metal matrix is 1 to 30 wt. %.

4. The cutting wheel according to claim 1, wherein the aluminum oxide particles are made of sintered corundum.

5. The cutting wheel according to claim 1, wherein the sintered metal matrix comprises 8 to 75 wt. % iron, nickel, tin and/or cobalt.

6. The cutting wheel according to claim 1, wherein the sintered metal matrix comprises 5 to 40 wt. % copper and/or copper-based alloy.

7. The cutting wheel according to claim 1, wherein the sintered metal matrix comprises 0.1 to 40 wt. % hard materials and/or hard-material alloy.

8. The cutting wheel according to claim 1, wherein the sintered metal matrix comprises 0.5 to 15 wt. % iron phosphide.

9. The cutting wheel according to claim 1, wherein the aluminum oxide particles are disposed regularly and/or in patterns in the sintered metal matrix.
